(19) United States
(12) Patent Application Publication
(10) Pub. No.: US 2009/0210690 A1
(43) Pub. Date: Aug. 20, 2009

(54) METHOD OF UPDATING BASIC INPUT OUTPUT SYSTEM AND MODULE AND COMPUTER SYSTEM IMPLEMENTING THE SAME

(75) Inventors: Chao-Chung Wu, Taipei (TW); Yu-Chen Lee, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/324,903

(22) Filed: Nov. 28, 2008

(30) Foreign Application Priority Data
Feb. 19, 2008 (TW) 97105768

(51) Int. Cl. G06F 15/177; G06F 12/00; G06F 12/16

(52) U.S. Cl. 713/2; 711/162; 711/E12.001; 711/E12.103

(57) ABSTRACT

A method for recovering a BIOS unit, an updating module thereof and a computer system are provided. When the computer system is in a standby mode, and the updating module is coupled with the computer system and detects that a first start unit is enabled, data in the BIOS unit of the computer system are overwritten with program codes stored in the storage unit.

### CROSS-REFERENCE TO RELATED APPLICATION

This application claims the priority benefit of Taiwan application serial no. 97105768, filed on Feb. 19, 2008. The entirety of the above-mentioned patent application is hereby incorporated by reference herein and made a part of this specification.

### BACKGROUND OF THE INVENTION

1. Field of the Invention

The invention relates to a method of updating basic input output system (BIOS) and, more particularly, to a method of updating BIOS by an update module, the module, and the computer system thereof.

2. Description of the Related Art

In a computer system, the basic input output system (BIOS) unit plays an important role. Generally, when the computer system is booted, the BIOS unit is run first to perform a power on self test (POST) to initialize peripherals and to perform functions such as executing a computer operating time after an operating system (OS) in the computer system is operated. Therefore, the computer system cannot be booted when the BIOS unit on a motherboard cannot be started because of damage, a recovery failure or other factors. When this happens, the BIOS unit needs to be recovered.

A conventional method for recovering the BIOS unit is performing the recovery action only when the computer system enters into a BIOS setup mode after booting. Therefore, when the computer system cannot be booted, a user cannot recover the BIOS unit by himself or herself, and he or she has to send the motherboard to a manufacturer to maintain it or to replace it with a new motherboard, which is quite inconvenient.

### BRIEF SUMMARY OF THE INVENTION

The invention provides a method for recovering a BIOS unit, an updating module thereof and a computer system. According to the invention, the BIOS unit can be recovered through the updating module when the computer system is in a standby mode.

The invention provides an updating module for a BIOS unit in a computer system. The updating module includes a first start unit, a storage unit and a control unit, wherein the control unit is coupled with the first start unit and the storage unit. The storage unit is used to store BIOS program codes. if the control unit determines that the updating module is coupled with the computer system and the first start unit is enabled in a state of a standby power providing by a motherboard of the computer system, the control unit overwrites program codes in the BIOS unit of the computer system using the backup program codes stored in the storage unit.

In an embodiment of the invention, the updating module further includes an interface unit and a second start unit, wherein the interface unit is used to couple the updating module to the computer system. The second start unit is coupled with the control unit. When the second start unit is enabled and the updating unit is coupled to the computer system, the control unit retrieves program codes in the BIOS unit of the computer system and backups them to the storage unit such as a flash memory.

Another aspect of the invention provides a computer system including a BIOS unit, an interface unit and an updating module. The updating module is coupled with the BIOS unit through the interface unit. The updating module includes a first start unit, a storage unit and a control unit. The storage unit is used to store backup program codes of BIOS and the control unit is coupled with the first start unit and the storage unit. When a motherboard of the computer system provides a standby power to the updating module through the interface unit, the control unit disables the connection between the BIOS unit and a chipset and controls to overwrite program codes in the BIOS unit of the computer system using the backup program codes stored in the storage unit. In an embodiment of the invention, the computer system further includes a second start unit. The second start unit is coupled with the control unit. When the second start unit is enabled, the control unit retrieves program codes of BIOS and backups them to the storage unit.

Still another aspect of the invention provides a method for recovering a BIOS unit of a computer system. First, a motherboard of the computer system provides a standby power to a pluggable backup unit and detects whether a first start signal is enabled. Then backup data of the pluggable backup unit is overwritten to the BIOS unit of the computer system.

In an embodiment of the invention, when the computer system is in a standby mode, the method further includes a step of retrieving the backup data from the pluggable backup unit to write to the BIOS unit through an interface unit.

In an embodiment of the invention, the method for recovering the BIOS unit further includes detecting whether a second start signal is enabled. When the second start signal is detected to be enabled, the program codes from the BIOS unit of the computer system are retrieved to be backuped to the pluggable backup unit.

In an embodiment of the invention, when a first start signal is detected to be enabled, the method further includes the step of disabling the connection between the BIOS unit and a chipset.

In the invention, a pluggable backup unit is directly inserted (or coupled) to a computer system, and the BIOS unit can be recovered when the computer system is in the standby mode. Therefore, even if the computer system cannot be booted, a user can still recover the BIOS unit by himself or herself to boot the computer system normally.

These and other features, aspects and advantages of the present invention will become better understood with regard to the following description, appended claims, and accompanying drawings.

### BRIEF DESCRIPTION OF THE DRAWINGS

FIG. 1 is a block diagram showing the computer system according to an embodiment of the invention.

FIG. 2 is a block diagram showing the updating module according to an embodiment of the invention.

FIG. 3A to FIG. 3C are block diagrams showing the BIOS unit and chipset according to an embodiment of the invention.

FIG. 4 is a flow chart showing the method for recovering the BIOS unit according to an embodiment of the invention.

FIG. 5 is a block diagram showing the computer system with a built-in updating module according to an embodiment of the invention.

FIG. 6 is a block diagram showing the updating module externally connected to the computer system according to an embodiment of the invention.

### DETAILED DESCRIPTION OF THE EMBODIMENTS

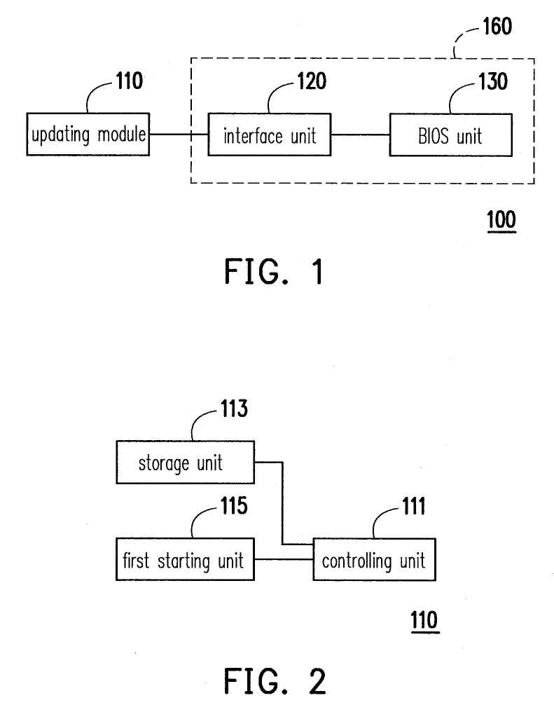

FIG. 1 is a block diagram showing a computer system according to an embodiment of the invention. As shown in FIG. 1, the computer system 100 provided in the embodiment of the invention includes an updating module 110, an interface unit 120, and a BIOS unit 130, wherein the interface unit 120 and the BIOS unit 130 are assembled in a motherboard 160.

In the embodiment, the updating module 110 can be coupled with the interface unit 120 selectively. Besides, in the embodiment, the updating module 110 has a plurality of pins.

The interface unit 120 is electrically connected with the BIOS unit 130. In the embodiment, the interface unit 120 can be a connector (or a connecting base). Therefore, the updating module 110 can be selectively inserted to the interface unit 120 to be coupled with the BIOS unit 130.

In the embodiment, the BIOS unit 130 is a flash memory for storing program codes of the BIOS unit. In other embodiments, the BIOS unit 130 also may be a read only memory (ROM) or another kind of nonvolatile memory.

Therefore, when the computer system 100 cannot be booted normally because of the abnormality of the BIOS unit 130, a power is provided to the motherboard 160 of the computer system 100 in the embodiment to make the motherboard 160 provide a standby power (such as five volts) to each element and connector on the motherboard 160. Thus, a user can insert the updating module 110 to the interface unit 120 of the motherboard 160, and then the updating module 110 obtains the standby power provided by the motherboard 160 through the interface unit 120 to check and recover the program codes in the BIOS unit 130. Furthermore, whether the BIOS unit 130 is normal also can be detected. An embodiment is provided to illustrate the function of each element in the updating module 110 in detail.

FIG. 2 is a block diagram showing the updating module according to an embodiment of the invention. As shown in FIG. 1 and FIG. 2, the updating module 110 includes a control unit 111, a storage unit 113 and a first start unit 115. The control unit 111 is coupled with the storage unit 113 and the first start unit 115 respectively. In the embodiment, the storage unit 113 also may be a flash memory to store backup program codes of BIOS, wherein the backup program codes of BIOS are corresponding to BIOS program codes in the BIOS unit 130.

In the embodiment, the first start unit 115 can be a key or a switch to allow a user to start the updating module 110 through the first start unit 115 to execute the recovery action of the BIOS unit 130.

When the computer system 100 cannot be booted normally because of the abnormality of the BIOS unit 130, the computer system 100 is connected to a power source to allow the motherboard 160 to provide a standby power. Thus, a user can insert the updating module 110 to the interface unit 120 of the motherboard 160. When the control unit 111 detects the first start unit 115 (such as a key) is enabled, the control unit 111 overwrites the BIOS program codes of the BIOS unit 130 with the program codes stored in the storage unit 113 through the interface unit 120 when the computer system 100 is in a standby mode.

Moreover, before the updating unit 110 recovers the BIOS unit 130, it disables the connection between the BIOS unit 130 and the chipset (not shown). That is, the BIOS unit 130 is isolated from the chipset to avoid the transmission of the signal for recovering the BIOS unit 130 to the chipset.

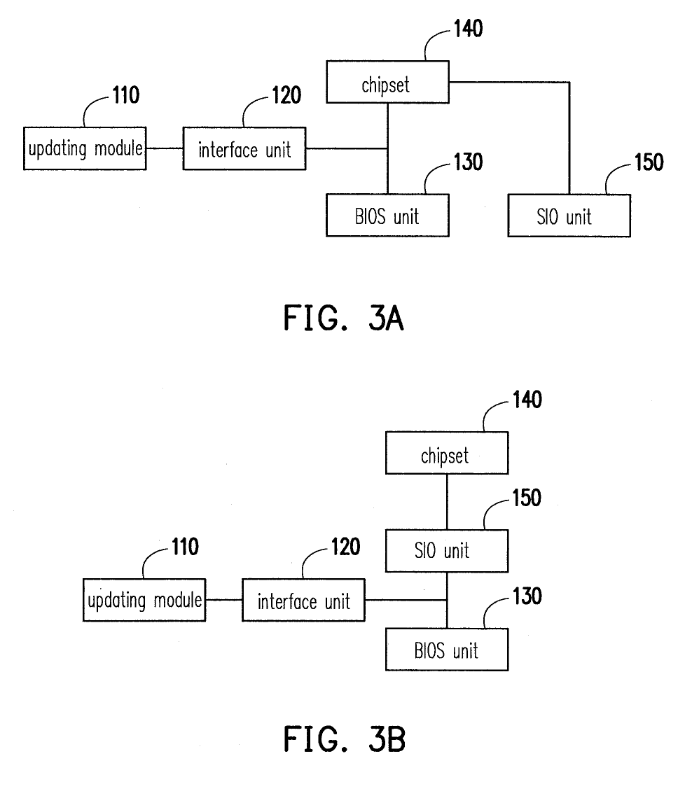

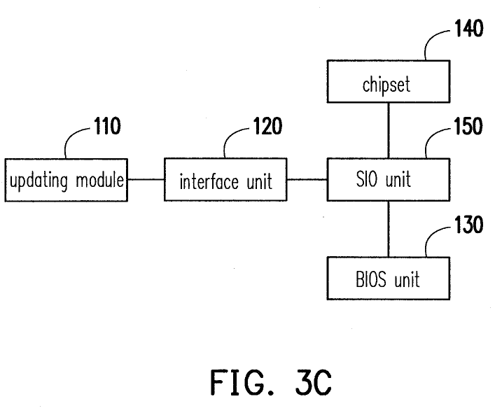

As far as the configuration of the motherboard is concerned, the BIOS unit 130 can be coupled with the chipset (such as a south bridge chip), or it can be coupled with the chipset through a super input output (SIO) unit. For example, FIG. 3A to FIG. 3C are block diagrams showing the BIOS unit 130 and the chipset according to an embodiment of the invention. In FIG. 3A, the chipset 140 is coupled with the BIOS unit 130 and the SIO unit 150 respectively. The chipset 140 is, for example, coupled with the BIOS unit 130 through a serial peripheral interface (SPI). The updating module 110 can be coupled between the chipset 140 and the BIOS unit 130 through the interface unit 120.

In FIG. 3B, the chipset 140 is coupled with the SIO unit 150 to be coupled with the BIOS unit 130 through the SIO unit 150. As far as the configuration of the motherboard is concerned the SIO unit 150 is, for example, coupled with the BIOS unit 130 through the low pin count (LPC) interface. The updating unit 110 is coupled between the SIO unit 150 and the BIOS unit 130 through the interface unit 120.

Furthermore, as shown in FIG. 3C, when the chipset 140 is coupled with the SIO unit 150 and then coupled with the BIOS unit 130 through the SIO unit 150, the updating module 110 also can be coupled with the SIO unit 150 through the interface unit 120.

In other embodiments, the interface unit 120 also may be a signal line. The updating module 110 is electrically connected with the BIOS unit 130 directly through the signal line. This can be changed according to a usage condition, and its application scope should not be limited.

In addition, in other embodiments, the control unit 111 of the updating module 110 can be a microprocessor, while another control unit (not shown) is disposed in the motherboard 160 of the computer system 100. The working power supply of the control unit can be the standby power (five volts) provided by the motherboard 160. Therefore, when the computer system 100 cannot be booted because of the abnormality of the BIOS unit 130, the control unit assembled in the motherboard 160 can operate as long as the motherboard 160 provides the standby power. Furthermore, the control unit can check whether the updating module 110 is coupled with the interface unit 120. If the updating module 110 is coupled with the interface unit 120, the control unit controls the updating module to recover the BIOS unit 130.

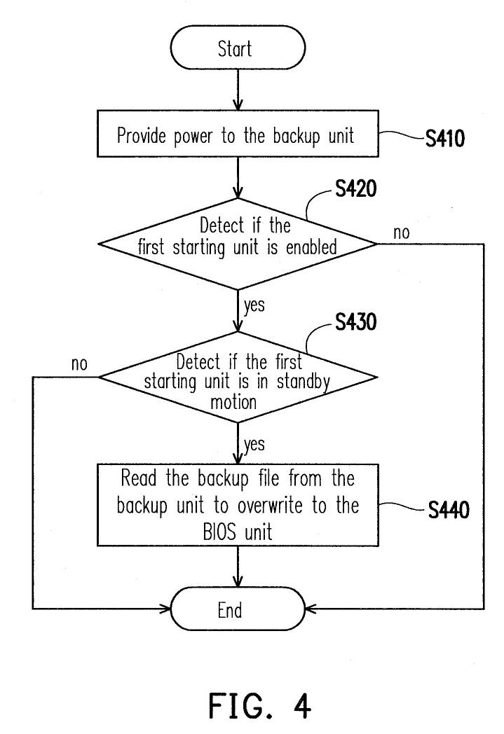

The steps of the method for recovering the BIOS unit 130 is described in detail with the computer system 100. FIG. 4 is a flow chart showing the method for recovering the BIOS unit according to an embodiment of the invention. As shown in FIG. 1, FIG. 2 and FIG. 4, first, in the step S410, a power is provided to a pluggable backup unit. In the embodiment, the pluggable backup unit is, for example, the updating module 110. For example, the power supply of the computer system 100 provides power for the motherboard 160 to allow the motherboard 160 to provide the standby power (five volts) to the updating module 110.

Afterward, in the step S420, the control unit 111 detects whether the first start signal is enabled. For example, the control unit 111 detects whether the first start signal sent by the first start unit 115 is received. That is, after a user enables the first start unit 115, the first start unit 115 sends the first start signal. If the first start signal is not detected to be enabled, the updating module 110 performs no action; on the contrary, if the first start signal is detected to be enabled, as shown in the step S430, the updating module 110 then detects whether the computer system 100 is in a standby mode to perform subsequent actions.

Moreover, when the first start unit 115 is enabled, the control unit 111 disables the connection between the BIOS unit 130 and the chipset 140 (as shown in FIG. 3A to FIG. 3C) to avoid transmitting the signal for recovering BIOS unit 130 to the chipset 140 during recovering.

The process returns to the step S430. If the computer system 100 is in the standby mode (an idle state), as shown in the step S440, the control unit 111 retrieves the backup program codes from the pluggable backup unit (namely, the storage unit 113 of the updating module 110) and overwrites data of the BIOS unit 130 with the backup program codes. In other words, the control unit 111 retrieves the backup program codes from the storage unit 113 and overwrites data of the BIOS unit 130 with the backup program codes through the interface unit 130. If the computer system finishes booting, it means that the BIOS unit 130 is not broken, and then it does not need to be recovered. If a user wants to recover the BIOS unit 130, he or she can recover the BIOS unit 130 via the pluggable backup unit.

The updating module 110 of the embodiment of the invention may be built in the computer system 100 or be externally connected to the computer system 100. These two conditions are illustrated in detail as follows with two embodiments.

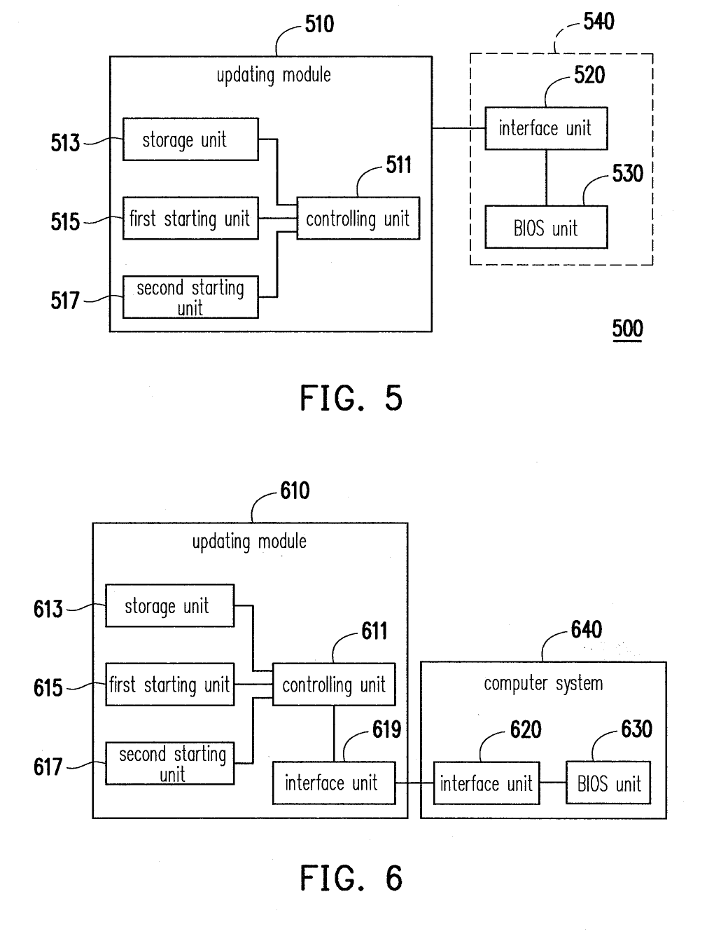

FIG. 5 is a block diagram showing the computer system with a built-in updating module according to an embodiment of the invention. As is shown in FIG. 5, the computer system 500 includes the updating module 510, the interface unit 520 and the BIOS unit 530. The interface unit 120 and the BIOS unit 130 are assembled in the motherboard 540. The interface unit 520 is, for example, a SPI. Thus, the updating module 510 is coupled to the BIOS unit 530 through the SPI. The interface unit 520 also may be, for example, a socket. Therefore, the updating module 510 can be inserted to the motherboard 540 through the socket.

The elements of the updating module 510 in this embodiment are the same or similar with the elements of the updating module 110 in the previous embodiment, and they are not described in detail herein. The difference is that the updating module 510 in the embodiment further includes a second start unit 517 coupled with the control unit 511. The function of the second start unit 517 is corresponding to the function of the first start unit 515. That is, when the second start unit 517 is enabled, the control unit 511 retrieves the program codes from the BIOS unit 530 and backups them to the storage unit 513.

That is, when the computer system is in the standby mode, the control unit 511 detects whether the second start signal is enabled. When the second start signal is detected to be enabled, that is, the second start unit 517 is enabled, program codes are retrieved from the BIOS unit 530 to be backuped to the storage unit 513 of the updating module 510.

In actual application, the first start unit 515 and the second start unit 517 can be disposed in the computer casing of the computer system 500 to allow the user to choose to recover the BIOS unit 530 or backup BIOS unit 530. Besides, the control unit 511 is, for example, an additionally disposed microprocessor rather than a central processing unit. Thus, the recovery action may be performed by only starting the control unit 511 when the computer system 500 is in the standby mode.

FIG. 6 is a block diagram showing the updating module externally connected to the computer system according to an embodiment of the invention. As shown in FIG. 6, the updating module 610 in the embodiment is externally connected to the computer system 640. The elements in the updating module 610 of the embodiment are the same or similar with the elements in the updating module 510, and they are not described in detail herein. The difference is that the updating module 610 in the embodiment further includes an interface unit 619.

The interface unit 620 of the computer system 640 and the interface unit 619 of the updating module 610 are, for example, I/O ports. Thus, the updating module 610 may be inserted to the interface unit 620 of the computer system 640 through the interface unit 619. When a user wants to recover the BIOS unit 630 in the computer system 640, he or she can insert the updating module 610 to the computer system 640. Then, the user enables the first start unit 615. The BIOS unit 630 can be recovered when the computer system 640 is in a standby mode. If the user enables the second start unit 617, the control unit 611 retrieves the program codes from the BIOS unit 630 in the computer system 640 and backups them to the storage unit 613.

In the embodiment, the first start unit 615 and the second start unit 617 are disposed in the updating module 610, and then the user can choose to recover the BIOS unit 630 or backup BIOS unit 630.

To sum up, in the embodiment, a user can recover BIOS program codes in the computer system through the updating module even when the computer is not booted or the operating system is not started, which is convenient.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An updating module for a BIOS unit in a computer system, the updating module comprising:
a first start unit;
a storage unit for storing backup program codes of BIOS; and
a control unit coupled with the first start unit and the storage unit, if the control unit determines that the updating module is coupled with the computer system and the first start unit is enabled in a state of a standby power providing by a motherboard of the computer system, the control unit overwrites program codes in the BIOS unit of the computer system using the backup program codes stored in the storage unit.

2. The updating module according to claim 1, further comprising an interface unit for coupling the updating module to the computer system.

3. The updating module according to claim 1, further comprising a second start unit coupled with the control unit, when the second start unit is enabled and the updating unit is coupled with the computer system, the control unit retrieves the program codes from the BIOS unit in the computer system and backups them in the storage unit to be the backup program codes.

4. A computer system comprising:
a BIOS unit;
an interface unit; and
an updating module coupled with the BIOS unit through the interface unit, the updating module comprising:
a first start unit;
a storage unit for storing a backup program codes of BIOS; and
a control unit coupled with the first start unit and the storage unit,
when a motherboard of the computer system provides a standby power to the updating module through the interface unit, the control unit disables the connection between the BIOS unit and a chipset, and the control unit overwrite program codes in the BIOS unit of the computer system using the backup program codes stored in the storage unit.

5. The computer system according to claim 4 further comprising:
a second start unit coupled with the control unit, wherein when the second start unit is enabled, the control unit retrieves the program codes from the BIOS unit and backups them in the storage unit.

6 The computer system according to claim 5, wherein the first start unit and the second start unit are disposed in a computer casing of the computer system.

7. A method for recovering a BIOS unit in a computer system, the step of the method comprising:
providing a standby power to a pluggable backup unit by a motherboard of the computer system;
detecting whether a first start signal is enabled; and
when the first start signal is enabled, overwriting data in the BIOS unit of the computer system with backup program codes from the pluggable backup unit.

8. The method for recovering according to claim 7, wherein the step of overwriting data in the BIOS unit of the computer system with backup program codes from the backup unit comprises:
reading the backup data from the pluggable backup unit through an interface unit to overwrite data in the BIOS unit.

9. The method for recovering according to claim 7, further comprising:
detecting whether a second start signal is enabled; and
when the second start signal is detected to be enabled, reading the program codes from the BIOS unit of the computer system to backup them to the pluggable backup unit.

10. The method for recovering according to claim 7, wherein when the first start signal is detected to be enabled, the method further comprises: disabling the connection between the BIOS unit and a chipset
